(19) United States
(12) Patent Application Publication
(10) Pub. No.: US 2020/0322506 A1
(43) Pub. Date: Oct. 8, 2020

(54) IMAGE PROCESSING SYSTEM, NON-TRANSITORY RECORDING MEDIUM, AND IMAGE PROCESSING METHOD

(71) Applicants: SCREEN HOLDINGS CO., LTD., Kyoto-shi, Kyoto (JP); WESTUNITIS CO., LTD., Osaka-shi, Osaka (JP)

(72) Inventors: Tetsuya IKEGAME, Kayoto-shi (JP); Kazunori YAMAGISHI, Kyoto-shi (JP); Takahito FUKUDA, Osaka-shi (JP)

(73) Assignees: SCREEN Holdings Co., Ltd., Kyoto-shi, Kyoto (JP); WestUnitis Co., Ltd., Osaka-shi, Osaka (JP)

(21) Appl. No.: 16/303,608

(22) PCT Filed: May 18, 2017
(86) PCT No.: PCT/JP2017/018690

§ 371 Date: Nov. 20, 2018

(30) Foreign Application Priority Data
May 24, 2016 (JP) 2016-103440

(51) Int. Cl. H04N 5/225; G06T 7/00

(52) U.S. Cl. CPC H04N 5/2253; G06T 7/0004; H04N 5/2257

(57) ABSTRACT

An image processing system includes an acquisition unit that acquires an original image capturing an original area, a recognition unit that recognizes one or more identifiers in the original image, an identification unit that identifies, based on the one or more identifiers recognized by the recognition unit, at least one of a first image portion capturing a first area in the original area or a second image portion capturing a second area that results from removing the first area from the original area, and a generation unit that generates a processed image including the first image portion in accordance with a result of identification from the identification unit. A certain image portion in the original image is automatically identified with the identifiers, and the processed image is generated in accordance with a result of the identification.

### TECHNICAL FIELD

The present invention relates to a technique for identifying some pieces of information included in an original image and generating a new image.

### BACKGROUND ART

For example, when a worker performs maintenance work at a worksite such as a factory, an instructor remote from the worksite may give the worker a procedure of the maintenance work in some cases.

Specifically, for example, there is a case where the worker informs the instructor of a situation at the worksite by call, and the instructor grasps the situation at the worksite based on contents of the call and gives an instruction to the worker. However, in such a case, it is difficult for the instructor to accurately grasp the situation only from the contents of the call, which may result in failure to make an appropriate instruction.

Accordingly, there is a case where the worker sends an image obtained from a picture taken of the worksite to the instructor, and the instructor grasps the situation of the worksite based on the image. However, in this case, confidential information at the worksite may be included in the image. In addition, when the worker carefully takes a picture of the worksite so that such confidential information is not included, a burden on the worker increases.

For example, Patent Document 1 discloses a system in which when a radio frequency identifier (RFID) tag attached to an object is detected by an RFID reader, a camera takes a picture of the object. This system causes timing where a picture is taken to be determined automatically, thereby lightening the burden on the worker.

### PRIOR ART DOCUMENT

Patent Document
Patent Document 1: Japanese Patent Application Laid-Open No. 2007-151001

### SUMMARY

### Problem to be Solved by the Invention

However, even with this system, confidential information at the worksite may be included in the image.

In addition to the above-described example concerning the protection of confidential information at the worksite, a technique for protecting various kinds of information (privacy information, copyright information, and the like) within a picture-taking range is desired.

The present invention has been made in view of such a problem, and it is an object of the present invention to provide a technique for reducing a risk of information leakage while lightening a burden on a picture-taker.

### Means to Solve the Problem

In order to solve the above-described problem, an image processing system according to a first aspect includes an acquisition unit acquiring an original image capturing an original area, a recognition unit recognizing one or more identifiers in the original image, an identification unit identifying, based on the one or more identifiers recognized by the recognition unit, at least one of a first image portion capturing a first area in the original area and a second image portion capturing a second area that results from removing the first area from the original area, and a generation unit generating a processed image including the first image portion in accordance with a result of identification from the identification unit.

An image processing system according to a second aspect is based on the image processing system according to the first aspect, in which the generation unit edits the second image portion to make the second area visually unrecognizable and generates the processed image that includes the first image portion and the second image portion thus edited.

An image processing system according to a third aspect is based on the image processing system according to the first aspect, in which the generation unit generates the processed image that does not include the second image portion but includes the first image portion.

An image processing system according to a fourth aspect is based on the image processing system according to any one of the first to third aspects and further includes an output unit visually outputting the processed image.

An image processing system according to a fifth aspect is based on the image processing system according to the fourth aspect, in which the output unit outputs the processed image immediately in response to acquisition of the first image in the acquisition unit.

An image processing system according to a sixth aspect is based on the image processing system according to the fourth aspect or the fifth aspect, in which when the identification unit fails to identify either the first image portion or the second image portion based on the one or more identifiers recognized by the recognition unit, a notification image for notifying a user of failure of identification is output to the output unit.

An image processing system according to a seventh aspect is based on the image processing system according to any one of the first to sixth aspects and further includes a housing that is portable and houses the acquisition unit, the recognition unit, the identification unit, and the generation unit, in which the acquisition unit is a picture-taking unit having the original area as a picture-taking range.

An image processing system according to an eighth aspect is based on the image processing system according to the seventh aspect and further includes a mounting unit that is provided outside the housing and mountable on a body of a picture-taker or a cloth of the picture-taker.

An image processing system according to a ninth aspect is based on the image processing system according to the seventh aspect or the eighth aspect and further includes a communication unit that is provided in the housing and capable of transmitting the processed image to a device located outside the housing.

An image processing system according to a tenth aspect includes a first terminal device including a picture-taking unit used by a picture-taker to take a picture of an original area to acquire an original image, a recognition unit recognizing an identifier for dividing the original image into a first image portion and a second image portion, an identification unit identifying, based on one or more of the identifiers recognized by the recognition unit, at least one of the first image portion capturing a first area to be provided to a viewer and the second image portion capturing a second area not to be provided to the viewer in the original image, and a generation unit generating, in accordance with a result of identification from the identification unit, a processed image including the first image portion having the first area visually recognizable and the second image portion edited to make the second area visually unrecognizable, and a second terminal device including a display unit displaying the processed image to the viewer.

An image processing system according to an eleventh aspect is based on the image processing system according to the tenth aspect, in which the first terminal device further includes a reception unit used by the picture-taker to receive information from the viewer.

An image processing system according to a twelfth aspect is based on the image processing system according to the tenth or eleventh aspect, in which the second terminal device further includes an input unit used by the viewer to input information to be given to the picture-taker in response to acquisition of the processed image.

An image processing program according to a thirteenth aspect is installed in a computer and executed in a memory by a CPU to cause the computer to function as the image processing system according to any one of the first to twelfth aspects.

An image processing method according to a fourteenth aspect includes disposing an identifier for defining a first image portion and a second image portion, acquiring an original image capturing an original area, recognizing one or more of the identifiers in the original image, identifying, based on the one or more identifiers thus recognized, at least one of the first image portion capturing a first area in the original area and the second image portion capturing a second area that results from removing the first area from the original area, and generating a processed image including the first image portion in accordance with a result of identification.

### Effects of the Invention

In any of the image processing system according to the first to twelfth aspects, the image processing program according to the thirteenth aspect, and the image processing method according to the fourteenth aspect, a certain image portion in the original image is automatically identified with the identifiers, and the processed image is generated in accordance with the result of the identification. Therefore, it is possible to reduce the risk of information leakage while lightening the burden on a picture-taker.

### BRIEF DESCRIPTION OF DRAWINGS

FIG. 1 is a diagram schematically showing an example of a configuration of an image processing system 1.

FIG. 2 is a perspective view showing an example of an appearance of a wearable tool 100.

FIG. 3 is a block diagram showing an example of an electrical configuration of the wearable tool 100.

FIG. 4 is a functional block diagram schematically showing an example of a configuration of a controller 110.

FIG. 5 is a flowchart showing a flow of processing to be performed by an image processor 114.

FIG. 6 is a diagram showing an example of an identifier 30 to be recognized by a recognition unit 115.

FIG. 7 is a diagram showing, as examples, original areas 171 to 173 taken by a camera 170 of the wearable tool 100.

FIG. 8 is a diagram showing, as an example, an original image 171a capturing the original area 171.

FIG. 9 is a diagram showing, as an example, an original image 172a capturing the original area 172.

FIG. 10 is a diagram showing, as an example, an original image 173a capturing the original area 173.

FIG. 11 is a diagram showing a processed image 174.

FIG. 12 is a diagram showing a notification image 175.

FIG. 13 is a diagram showing a processed image 174A according to a modification.

FIG. 14 is a diagram showing an original image 171aB according to the modification.

FIG. 15 is a diagram showing a processed image 174B according to the modification.

### DESCRIPTION OF EMBODIMENT

Hereinafter, an example of the embodiment and various modifications will be described with reference to the drawings. Note that, in the drawings, the same reference numerals are given to parts having similar configurations and functions, and redundant explanations are omitted in the following description. Further, the drawings are schematic illustrations, and sizes, positional relationships, and the like of various structures in each drawing may be appropriately changed.

### 1 Example of Embodiment

<1.1 Schematic Configuration of Image Processing System>

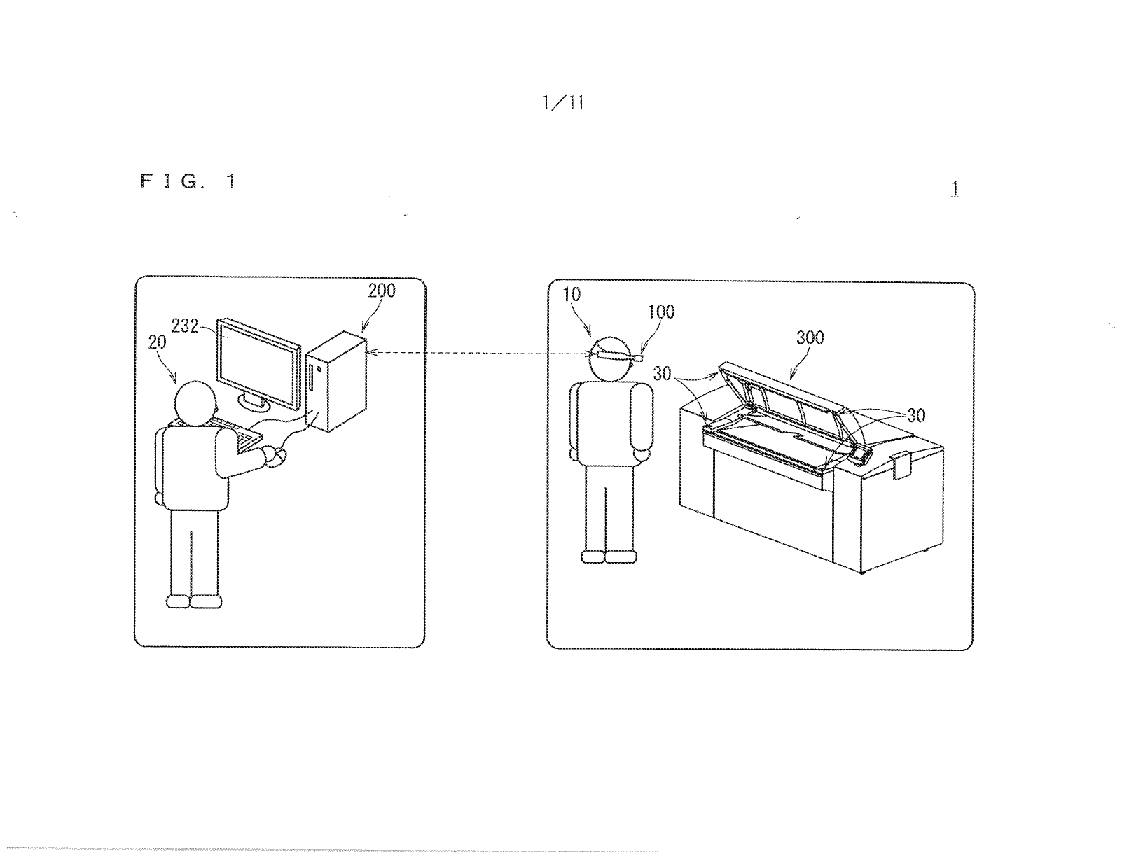

FIG. 1 is a diagram schematically showing an example of a configuration of an image processing system 1.

The image processing system 1 is a system to be used between a picture-taker who takes a picture of a certain area and a viewer who views at least a part of the taken picture. Hereinafter, as an example, a description will be given of a configuration where the image processing system 1 is used between a worker 10 (a picture-taker) who performs a maintenance work on a printing device 300 at a worksite, that is, a printing office, where the printing device 300 is installed and an instructor 20 (a viewer) who gives the worker 10 a procedure of the maintenance work from a remote place outside the printing office.

The image processing system 1 according to the present embodiment includes a wearable tool 100 serving as a first terminal device that is used by a worker 10 to take a picture of a situation at the worksite, and a personal computer (PC) 200 serving as a second terminal device that is capable of bidirectional communication with the wearable tool 100 and is used by an instructor 20.

In the image processing system 1, the worker 10 uses the wearable tool 100 to take a picture of a scene at the worksite in a form of a moving picture. Then, the wearable tool 100 generates a processed image from an original image obtained through the picture-taking and transmits the processed image to the PC 200. The instructor 20 uses the PC 200 to check the processed image and gives, to the worker 10, details for the maintenance work by call or through input from the PC 200.

Here, the processed image corresponds to an image including a first image portion relating to the maintenance work in the original image and a second image portion that is a remaining image portion of the original image and edited (for example, an image portion that should not be given to the instructor 20 such as confidential information at the worksite). Details of the image processing in the wearable tool 100 will be described later.

<1.2 Details of Wearable Tool>

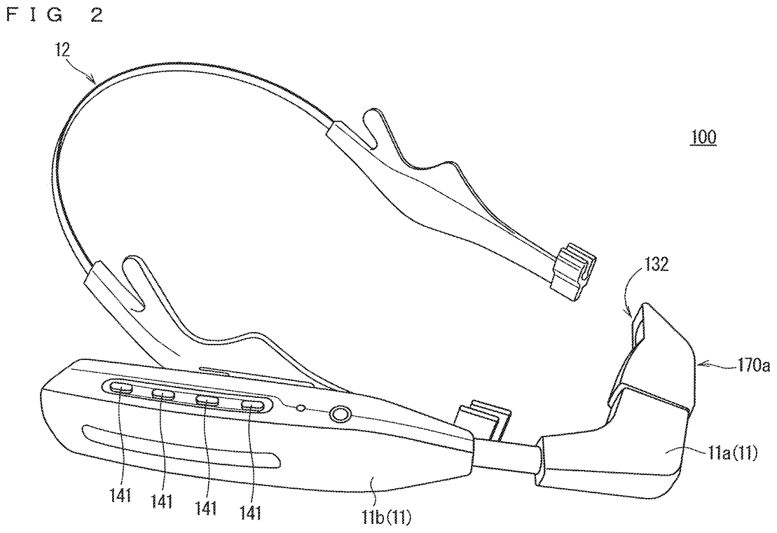

FIG. 2 is a perspective view showing an example of an appearance of the wearable tool 100. First, with reference to FIG. 2, a configuration of an appearance of the wearable tpol 100 will be described.

The wearable tool 100 includes a housing 11 that is portable and houses each functional unit relating to image processing, and a mounting unit 12 that is provided outside the housing 11 and is mountable on a head of the worker 10.

With the wearable tool 100 mounted on the worker 10, the housing 11 includes a front portion 11a positioned in front of the right eye of the worker 10 and a side portion 11b positioned adjacent to the right ear of the worker 10.

On a surface of the front portion 11a that faces the right eye of the worker 10, a display screen 132 is provided, which allows the worker 10 to visually confirms various kinds of information (for example, the processed image) via the display screen 132. Further, on a surface of the front portion 11a on the opposite side from the display screen 132, a lens 170a of a camera 170 to be described later is provided, which allows a forward visual field of the worker 10 wearing the wearable tool 100 to be taken through the lens 170a into the wearable tool 100 and formed into an image. Accordingly, a range substantially identical to a visual field of the right eye of the worker 10 is taken as a picture-taking area and formed into an image by the wearable tool 100, and then the resultant image is input to a controller 110.

A microphone hole and a receiver hole (not shown) are provided through the side portion 11b. The side portion 11b is further provided with various operation buttons 141 (a button for switching ON and OFF of picture-taking, a button for start or stop of communication with the PC 200, and a button for switching ON and OFF of a call function, and the like) the worker 10 can operate. This configuration allows the worker 10 to give various instructions to the wearable tool 100 by operating various operation units with a finger or the like.

The mounting unit 12 is formed of a substantially U-shaped frame that is curved to fit a back of the head of the worker 10. Further, the housing 11 and the mounting unit 12 are fixed to each other in the vicinity of the right ear of the worker 10 wearing the wearable tool 100.

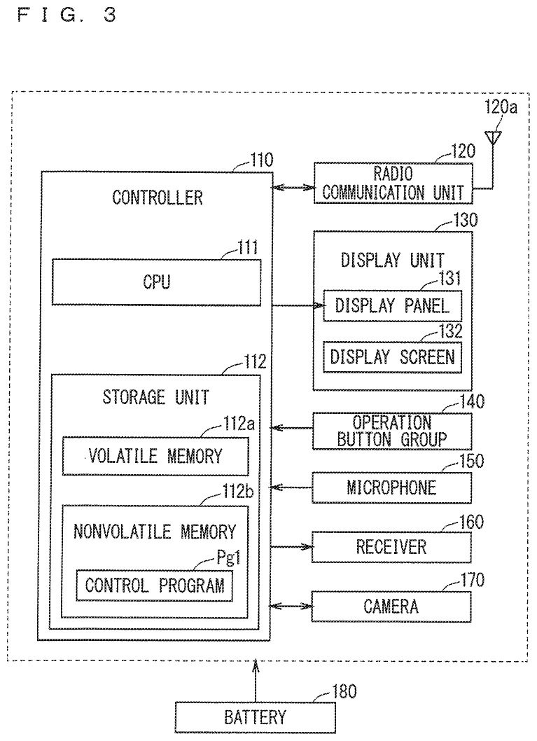

FIG. 3 is a block diagram showing an example of an electrical configuration of the wearable tool 100. As shown in FIG. 3, the wearable tool 100 includes the controller 110, a radio communication unit 120, a display unit 130, an operation button group 140, a microphone 150, a receiver 160, the camera 170, and a battery 180. Each of these components the wearable tool 100 includes is housed in the housing 11.

The controller 110 is a kind of arithmetic processing unit, and includes, for example, a central processing unit (CPU) 1 that is an electric circuit, a storage unit 112, and the like. The controller 110 is capable of controlling other components of the wearable tool 100 for centralized management of an operation of the wearable tool 100. The controller 110 may further include a co-processor such as a system-on-a-chip (SoC), a micro control unit (MCU), or a field-programmable gate array (FPGA). Further, the controller 110 may cause both the CPU and the co-processor to operate in conjunction with each other or may selectively use either the CPU or the co-processor to perform various kinds of control. Further, all or some of functions of the controller 110 may be implemented by hardware that needs no software for the implementation of the functions.

The storage unit 112 includes a recording medium the CPU 111 can read, such as a read only memory (ROM) and a random access memory (RAM). The ROM the storage unit 112 includes is, for example, a flash ROM (flash memory) that is a nonvolatile memory 112b. Further, the RAM the storage unit 112 includes is, for example, a volatile memory 112a. The storage unit 112 stores a main program, a plurality of application programs (hereinafter, each simply referred to as an “application” in some cases), and the like for controlling the wearable tool 100. The various functions of the controller 110 are implemented by the CPU 111 executing each of the various programs in the storage unit 112. The storage unit 112 stores, for example, a call application for making a voice call, a picture-taking application for taking a still image or a moving image using the camera 170, and the like. Further, the applications stored in the storage unit 112 include, for example, a control program Pg1 for controlling the wearable tool 100.

Note that the storage unit 112 may include a non-transitory computer-readable recording medium other than the ROM and the RAM. The storage unit 112 may include, for example, a small hard disk drive and a solid state drive (SSD).

The radio communication unit 120 includes an antenna 120a. The radio communication unit 120 functions as, for example, a reception unit that receives, via the antenna 120a, a signal that is transmitted via a base station from the PC 200 connected to the Internet. Further, the radio communication unit 120 is capable of performing predetermined processing such as amplification processing and down-conversion on the signal received via the antenna 120a and outputting the reception signal thus processed to the controller 110. The controller 110 is capable of performing demodulation processing and the like on the reception signal thus input to acquire information such as a signal (also referred to as a voice signal) representing voice, music, or the like from the reception signal.

Further, the radio communication unit 120 functions as a transmission unit that performs predetermined processing such as up-conversion and amplification processing on a transmission signal generated by the controller 110, and transmits wirelessly the transmission signal thus processed via the antenna 120a. The transmission signal transmitted via the antenna 120a is received, via the base station, by a communication device such as the PC 200 connected to the Internet, for example.

The display unit 130 includes a display panel 131 and a display screen 132. The display panel 131 is, for example, a liquid crystal panel or an organic electro-luminescence (EL) panel. The display panel 131 is capable of visually outputting various kinds of information such as characters, symbols, and figures under control of the controller 110. The various kinds of information visually output by the display panel 131 are displayed on the display screen 132. Further, the PC 200 is also provided with a display panel and a display screen 232, and various kinds of information visually output by the display panel are displayed on the display screen 232. In a video call to be described later, the same image (for example, the processed image) may be shared between the two display screens 132 and 232.

Each of the operation buttons 141 belonging to the operation button group 140, when being operated by the worker 10, outputs an operation signal indicating that the operation button 141 has been operated to the controller 110. This configuration allows the controller 110 to determine, based on the operation signal from each of the operation buttons 141, whether the operation button 141 has been operated. The controller 110 can perform processing associated with the operation button 141 thus operated. Note that each of the operation buttons 141 may not be a hardware button such as a push button, but a software button that reacts to a touch of a hand of the worker 10. In this case, an operation on the software button is detected by a touch panel (not shown), and the controller 110 can perform processing associated with the software button thus operated. Further, an input method is not limited to the physical contact on the operation buttons 141, the software buttons, or the like, and may be a method in which various operations are performed by voice recognition with the microphone 150 without physical contact.

The microphone 150 is capable of converting a voice input from the outside of the wearable tool 100 into an electrical voice signal and outputting the electrical voice signal to the controller 110. The voice from the outside of the wearable tool 100 is taken into the wearable tool 100 through the microphone hole (not shown) provided through the housing 11 and is input to the microphone 150, for example.

The receiver 160 is, for example, a dynamic speaker. The receiver 160 is capable of converting an electrical voice signal output from the controller 110 into a voice and outputting the voice. The receiver 160 outputs, for example, an incoming voice. The voice output from the receiver 160 is output to the outside through the receiver hole (not shown) provided through the housing 11, for example.

The camera 170 is composed of a lens, an image sensor, and the like. The camera 170 functions, under control of the controller 110, as a picture-taking unit that takes a picture of a subject, generates a still image or a moving image capturing the subject, and outputs the still image or the moving image to the controller 110. The controller 110 can store the still image or the moving image thus input into the nonvolatile memory 112b or the volatile memory 112a of the storage unit 112.

The battery 180 is capable of outputting electric power necessary for the operation of the wearable tool 100. The battery 180 is, for example, a rechargeable battery such as a lithium ion secondary battery. The battery 180 can supply electric power to various electronic components such as the controller 110 and the radio communication unit 120 the wearable tool 100 includes.

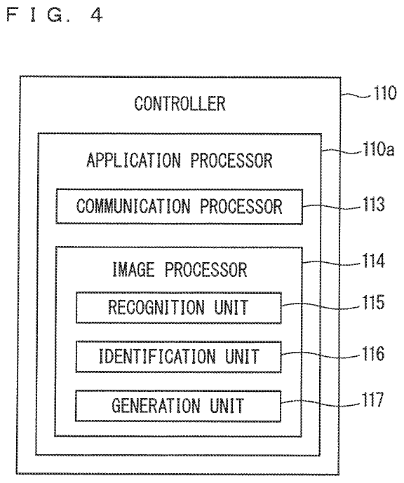

FIG. 4 is a functional block diagram schematically showing an example of a configuration of the controller 110. FIG. 4 shows particularly a functional unit relating to a video call between the wearable tool 100 and the PC 200, among the functional units the controller 110 includes. In addition to the functional units shown in FIG. 4, the controller 110 includes, for example, respective controllers that respectively control the display unit 130, the microphone 150, the receiver 160, the camera 170, and the like.

The controller 110 includes an application processor 110a. For example, the application processor 110 a reads and executes an application stored in the storage unit 112 to cause various functions of the wearable tool 100 to work. For example, the application processor 110a is capable of causing the call function, a picture-taking function, an image processing function, and the like to work. Further, the application thus executed includes, for example, the control program Pg1.

A functional component implemented by the application processor 110a includes, for example, a communication processor 113 and an image processor 114. These functional units may be implemented by software, or all or some of the functional units may be configured with hardware.

For example, the communication processor 113 is capable of performing communication processing together with an external communication apparatus. In the communication processing, for example, a voice signal or an image signal may be transmitted to the external communication apparatus via the radio communication unit 120. Further, in the communication processing, for example, a voice signal or an image signal may be received from the external communication apparatus via the radio communication unit 120.

A description will be given below as an example of a case where when the wearable tool 100 and the PC 200 perform the communication processing, a voice signal and an image signal are transmitted from the wearable tool 100 to the PC 200, and only a voice signal is transmitted from the PC 200 to the wearable tool 100. In this case, the worker 10 acquires voice information (for example, voice information on a flow of maintenance work) from the instructor 20, and the instructor 20 acquires voice information (for example, a question regarding the maintenance work) and image information on a worksite (for example, an image capturing an inside of the printing device 300) from the worker 10.

For example, when the communication processor 113 receives an incoming call signal from the instructor 20 via the radio communication unit 120, the communication processor 113 can notify the worker 10 of the incoming call. In response to this notification, the worker 10 operates a predetermined operation button 141 to start a call.

Further, the communication processor 113 can transmit an outgoing call signal to a communication partner via the radio communication unit 120 in response to the input from the worker 10. For example, the worker 10 can use a contact list stored in the storage unit 112 to designate a partner device. In the contact list, a plurality of pieces of personal information are registered. In each piece of personal information, a name and device identification information for identifying a device owned by a person having the name (a mobile phone, a PC, or the like) are associated with each other. The wearable tool 100 can use the device identification information to make a call with the partner device. The wearable tool 100 uses a telephone number or other device identification information to make the call.

For example, in a state where the wearable tool 100 displays personal information on an individual listed in the contact list, the worker 10 can instruct the wearable tool 100 to make a voice call or a video call. Then, in response to an operation performed by the worker 10 on the wearable tool 100, a personal information screen including a certain piece of personal information included in the contact list is displayed on the display screen 132.

For example, when the worker 10 operates one of the operation buttons 141 to instruct the wearable tool 100 to make a video call with the PC 200, the controller 110 reads and executes the call application and the picture-taking application from the storage unit 112. Then, a video call is made to the PC 200 that is the designated partner device.

During the video call, the communication processor 113 can cause the receiver 160 to output a voice signal received from the PC 200, and transmit a voice signal input via the microphone 150 and an image signal obtained from a picture taken by the camera 170 to the PC 200.

For example, when the worker 10 of the wearable tool 100 is watching the inside of the printing device 300 in the video call during maintenance work, a range substantially identical to the visual field of the right eye of the worker 10 (that is, a certain range of the inside of the printing device 300 viewed with the right eye of the worker 10) is taken as a picture-taking area of the wearable tool 100. Then, the image processor 114 to be described later generates a processed image based on an original image capturing the picture-taking area, and transmits the processed image to the PC 200.

When the worker 10 operates one of the operation buttons 141 to terminate the video call, the communication processing run by the communication processor 113 is also terminated.

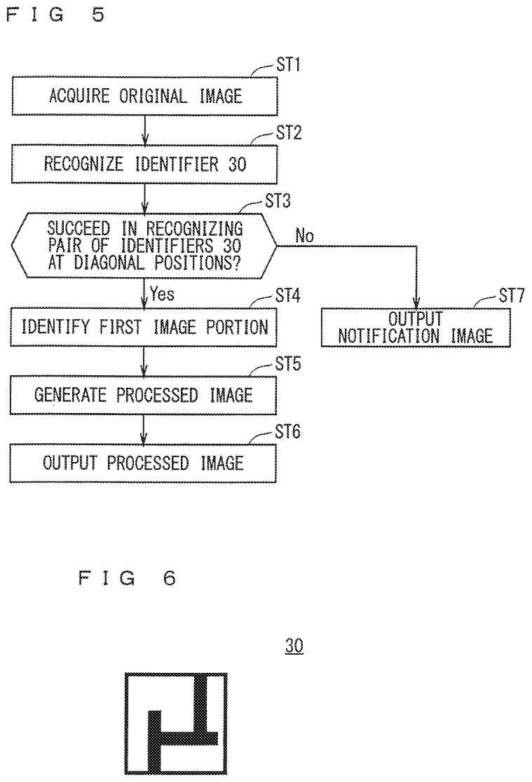

FIG. 5 is a flowchart showing a flow of processing to be performed by the image processor 114. This flow is implemented by the CPU 111 executing the control program Pg1 in the nonvolatile memory 112b.

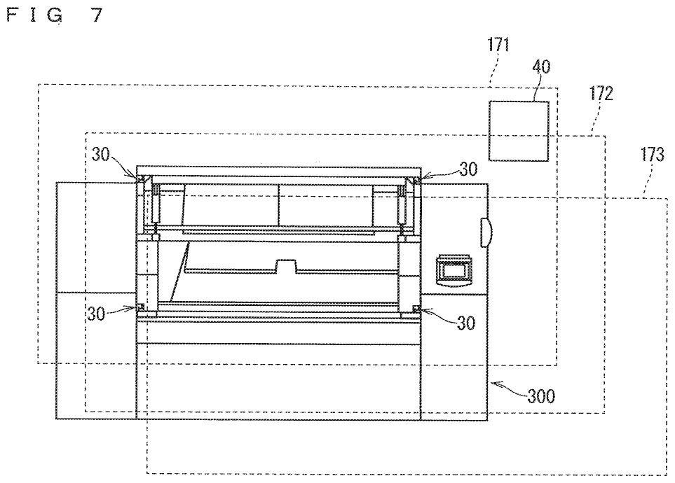

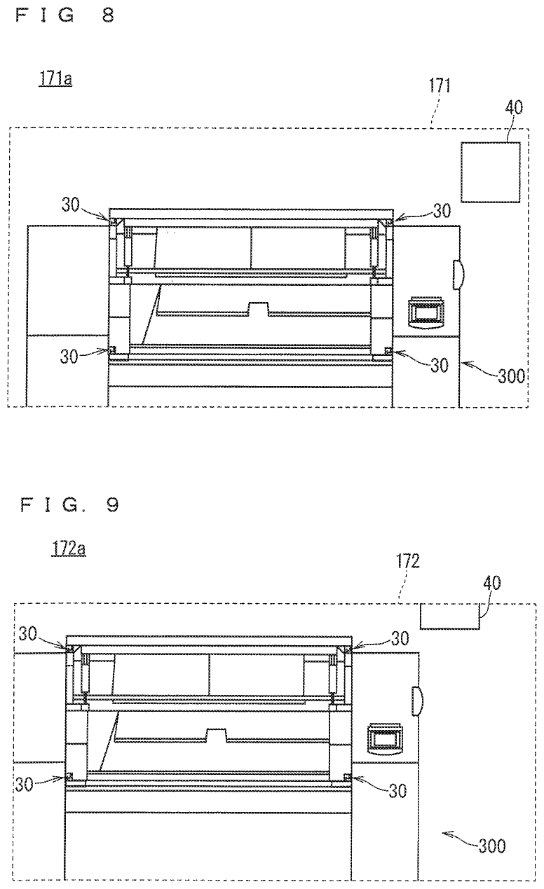

FIG. 6 is a diagram showing an example of an identifier 30 to be recognized by a recognition unit 115. FIG. 7 is a diagram showing, as examples, the original areas 171 to 173 taken by the camera 170 of the wearable tool 100. FIGS. 8 to 10 are diagrams showing, as examples, original images 171a to 173a capturing the original areas 171 to 173. In the present specification, an image acquired by the camera 170 is referred to as an original image for the purpose of distinguishing the image from the processed image. Further, in the present specification, a picture-taking area taken by the camera 170 is referred to as an original area for the purpose of distinguishing the picture-taking area from an area the processed image captures. A description will be given below of details of the image processor 114 with reference to each of the drawings.

In the present embodiment, the camera 170 functions as an acquisition unit that acquires an original image. The original image, upon being acquired by the camera 170, is stored in, for example, the volatile memory 112a of the storage unit 112 (step ST1). For example, in a case where the camera 170 serves as an acquisition unit that acquires a moving image, the original area varies with the movement of the worker 10 wearing the wearable tool 100, and original images capturing different areas are successively acquired.

Here, the original image 171a is an image that captures a whole of an internal area of the printing device 300 (specifically, a rectangular area surrounded by the four identifiers 30) and a whole of confidential information 40. The original image 172a is an image that captures the whole of the internal area of the printing device 300 and part of the confidential information 40. The original image 173a is an image that captures part of the internal area of the printing device 300. Here, for example, the confidential information 40 is information the worker 10 who performs the maintenance work on the printing device 300 at the worksite of the printing office where the printing device 300 is installed is allowed to visually confirm, but the instructor 20 who is at the outside of the printing office is not allowed to visually confirm.

In order for the worker 10 to share the situation inside the printing device 300 with the instructor 20, it is desirable that an image including the whole of the internal area be transmitted from the wearable tool 100 to the PC 200. In contrast, from the viewpoint of reducing risk of information leakage, it is desirable that the confidential information 40 be not included in the image to be transmitted from the wearable tool 100 to the PC 200.

Therefore, the image processor 114 generates a processed image that includes the whole of the internal area and does not include the confidential information 40 along the flow shown in FIG. 5. Then, the processed image is output from the wearable tool 100 to the PC 200. The image processor 114 includes the recognition unit 115, an identification unit 116, and a generation unit 117. Note that prior to the image processing performed by the image processor 114, one or more identifiers 30 are disposed within a range in which the worker 10 or the like may cause the camera 170 to acquire a moving image (within a range of the original area that varies with the movement of the worker 10).

The recognition unit 115 recognizes the one or more identifiers 30 in the original image (step ST2). As shown in FIGS. 1 and 6, in the present embodiment, identifiers 30 (a total of four identifiers 30) are provided at four corners of the printing device 300 with a cover of the printing device 300 for maintenance opened. Each of the identifiers 30 has a function of dividing the original image into the first image portion and the second image portion to be described later. In the present embodiment, the identifier 30 is defined and used as an object that defines a range (area) to be shared with the instructor 20, the range being within a visual field (that is, an image) and including no confidential information. Specifically, the identifier 30 is, for example, a seal having a two-dimensional code. Here, the seal is an indicator that has a front surface processed by a method such as printing so as to allow the camera 170 to recognize any two-dimensional symbol, figurer signal, or the like when being irradiated with an electromagnetic wave having any wavelength including colors of visible light, ultraviolet light, infrared light, and the like. On a back surface of the seal, an attachment structure such as an adhesive sheet, a magnetic sheet, a clip, or a suction cup is provided. Then, the identifier 30 is attached by a user (for example, the worker 10) to a portion. The portion corresponds to a device or a peripheral portion of the device, of which a picture is to be taken by the wearable tool 100, and the portion is to be a visual field to be shared with the instructor 20. More specifically, the identifier 30 is attached to an area that includes no confidential information, and achieves a function of indicating a type of the area (in the present embodiment, an area that includes no confidential information).

When the recognition unit 115 recognizes at least two identifiers 30 (also referred to as a pair of identifiers 30) located at diagonal positions among the four identifiers 30, a branch is made to Yes in step ST3. In contrast, when none of the two pairs of identifiers 30 is recognized by the recognition unit 115, a branch is made to No in step ST3.

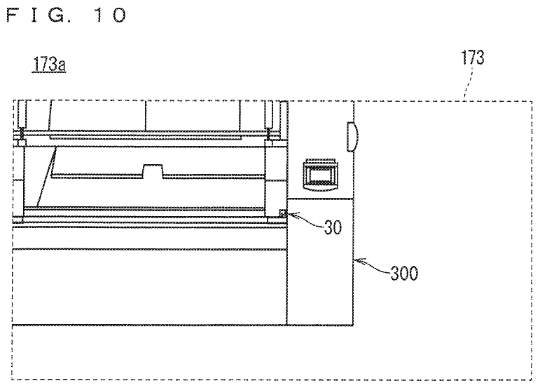

For example, in the original image 171a shown in FIG. 8 and the original image 172a shown in FIG. 9, four identifiers 30 (two pairs of 30) are recognized by the recognition unit 115, and a branch is made to Yes in step ST3. In contrast, in the original image 173a shown in FIG. 10, only one identifier 30 located at a lower right in the drawing is recognized by the recognition unit 115, and a branch is made to No in step ST3.

When the branch is made to Yes in step ST3, the identification unit 116 identifies the first image portion capturing the first area in the original area based on the one or more identifiers 30 recognized by the recognition unit 115 (step ST4). Here, the first area is an area including information to be transmitted from the wearable tool 100 to the PC 200, and is, in the present embodiment, identical to the internal area of the printing device 300 (specifically, the rectangular area surrounded by the four identifiers 30). Further, the second area is an area resulting from excluding the first area from the original area, and the second image portion is an image capturing the second area.

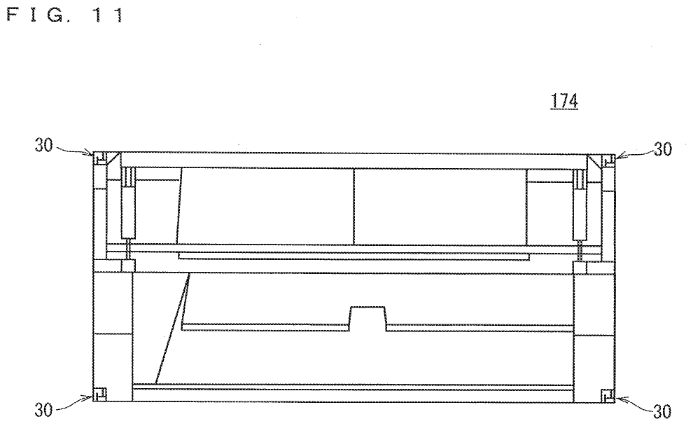

The generation unit 117 generates a processed image including the first image portion and not including the confidential information 40 in accordance with to a result of identification from the identification unit 116 (step ST5). FIG. 11 shows a processed image 174 that is an example of this processed image. As shown in FIG. 11, the generation unit 117 generates the processed image 174 that does not include the second image portion but includes the first image portion.

Then, the processed image 174 thus generated is output to the radio communication unit 120 and the display unit 130 (step ST6). As a result, the processed image 174 is displayed simultaneously on the display screen 232 of the PC 200 and the display screen 132 of the wearable tool 100. As described above, in the present embodiment, the first image portion in the original image 171a is automatically identified using the identifier 30, and the processed image 174 is generated in accordance with the result of the identification. Then, the processed image 174 is displayed on the display screens 132, 232. As described above, the processed image 174 includes no confidential information 40, thereby preventing the instructor 20 outside the printing office from seeing the confidential information. Further, the above-described processing is performed in the wearable tool 100 located inside the printing office, thereby preventing the confidential information 40 from being transmitted to the outside of the printing office. Therefore, it is possible to reduce the risk of information leakage while lightening the burden on the picture-taker.

Further, the processed image 174 is displayed on the display screens 132, 232 immediately in response to the acquisition of the original image 171a in the camera 170. Accordingly, the above-described image processing and image sharing are performed in real time during the video call between the worker 10 and the instructor 20, thereby making smooth communication between the worker 10 and the instructor 20.

Further, when the branch is made to No in step ST3, that is, when the identification unit 116 fails to identify the first image portion based on the one or more identifiers 30 recognized by the recognition unit 115, a notification image for notifying the worker 10 of the failure of identification is output to the radio communication unit 120 and the display unit 130 (step ST7). Then, the notification image is displayed simultaneously on the display screen 232 of the PC 200 and the display screen 132 of the wearable tool 100.

FIG. 12 shows a notification image 175 that is an example of the notification image in this case. The notification image 175 is, for example, an image stored in advance in the nonvolatile memory 112b. In the present embodiment, the notification image 175 includes character information of “Confidential”, and the worker 10 and the instructor 20 are informed that the original image may include confidential information.

As described above, when the identification unit 116 succeeds in identifying the first image portion, the processed image 174 is output, and when the identification unit 116 fails to identify the first image portion, the notification image 175 is output. Therefore, it is possible to effectively reduce the risk of leakage of confidential information.

Further, when the identification unit 116 fails to identify the first image portion, the notification image 175 is output to not only the display screen 232 but also the display screen 132. Accordingly, the worker 10 easily notices that a direction and the like of the wearable tool 100 need to be adjusted so that each identifier 30 lie within a picture-taking range of the camera 170. As a result, the worker 10 can make this adjustment in a short time and transmit the processed image 174 to the instructor 20 again.

As described above, in the video call according to the present embodiment, a switch between the processed image 174 and the notification image 175 to be displayed on the display screens 132, 232 is automatically made in accordance with the result of recognition of the identifiers 30 from the recognition unit 115. As described above, each identifier 30 has a function of restricting an image range when the processed image 174 is generated, and a function of switching images to be displayed.

Then, when the worker 10 or the instructor 20 performs an operation to terminate the video call or when the wearable tool 100 or the PC 200 is powered off, the execution of the control program Pg1 in the controller 110 is terminated. As a result, the flow shown in FIG. 5 comes to an end, and the image display on the display screens 132, 232 is terminated. Further, the call between the worker 10 and the instructor 20 is terminated.

### 2 Modification

Although a description has been given of the embodiment of the present invention, various modifications other than the embodiment described above can be made without departing from the spirit of the present invention.

In the above-described embodiment, although a description has been given of the configuration where the generation unit 117 generates the processed image 174 (FIG. 11) that does not include the second image portion but includes the first image portion, the present invention is not limited to this configuration. For example, an aspect may be employed in which the generation unit edits the second image portion to make the second area visually unrecognizable and then generates a processed image including the first image portion having the first area visually recognizable and the second image portion thus edited.

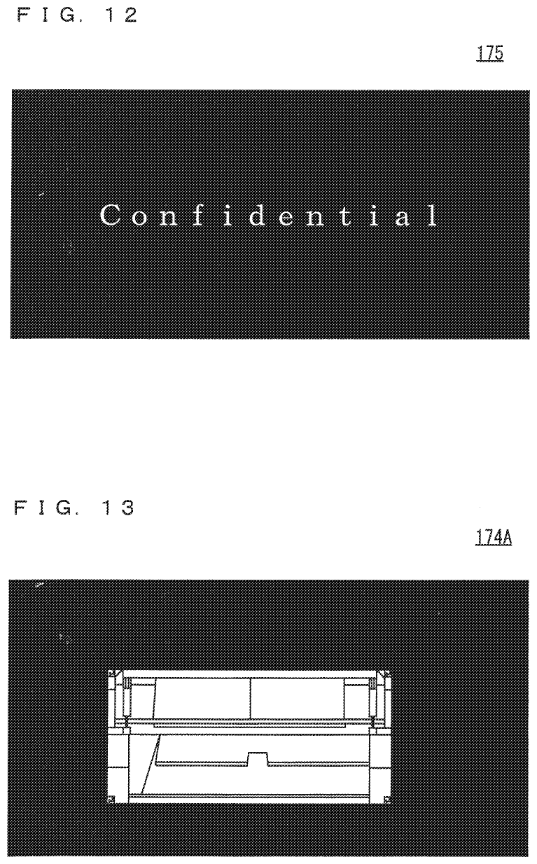

FIG. 13 is a diagram showing, as an example of the processed image, a processed image 174A according to a modification. The processed image 174A is an image that includes the first image portion in the original image 171a without any change, and the second image portion in the original image 171a on which a layer filled with black is superimposed. As a result, in the processed image 174A, the second area is made visually unrecognizable. The second area is an area other than the first area (an area that includes no confidential information and is to be shared with the instructor 20) defined by the identifiers 30, and is an area that may include confidential information. Therefore, in this modification, the risk of information leakage is reduced.

Further, position and size of the first image portion relative to the whole image in the processed image 17A are identical to those in the processed image 174. Therefore, when processed image 174A is displayed on the display screens 132, 232, the worker 10 and the instructor 20 can easily grasp the worker 10 and the position and size of the first image portion relative to the whole image. In contrast, in the processed image 174 according to the above-described embodiment, the first image portion is enlarged and displayed on the display screens 132, 232, which helps the worker 10 and the instructor 20 easily grasp details of the first image portion. Further, in the processed image 174 according to the above-described embodiment, even when the original area varies due to shaking of the head of the worker 10 or the like, the processed image 174 displayed on the display screens 132, 232 does not vary. Therefore, the burden on the worker 10 and the instructor 20 viewing the display screens 132, 232 is lightened.

As the aspect in which the generation unit edits the second image portion to make the second area visually unrecognizable and then generates a processed image including the first image portion and the second image portion thus edited, various aspects other than the above-described aspect according to the modification may be employed. For example, an aspect in which the second image portion is replaced with a preliminarily prepared image (for example, an image filled with a solid color), an aspect in which filtering processing (for example, mosaic processing) is performed on the second image portion, or an aspect in which the second image portion is scrambled may be employed.

Further, in the above-described embodiment, although a description has been given of the aspect in which the identification unit 116 identifies the first image portion capturing the first area in the original area based on the one or more identifiers 30 recognized by the recognition unit 115, the present invention is not limited to this aspect. For example, an aspect may be employed in which the identification unit identifies the second image portion capturing the second area that results from removing the first area from the original area. That is, in this aspect, the identifier 30 is defined and used as an object indicating an area including confidential information.

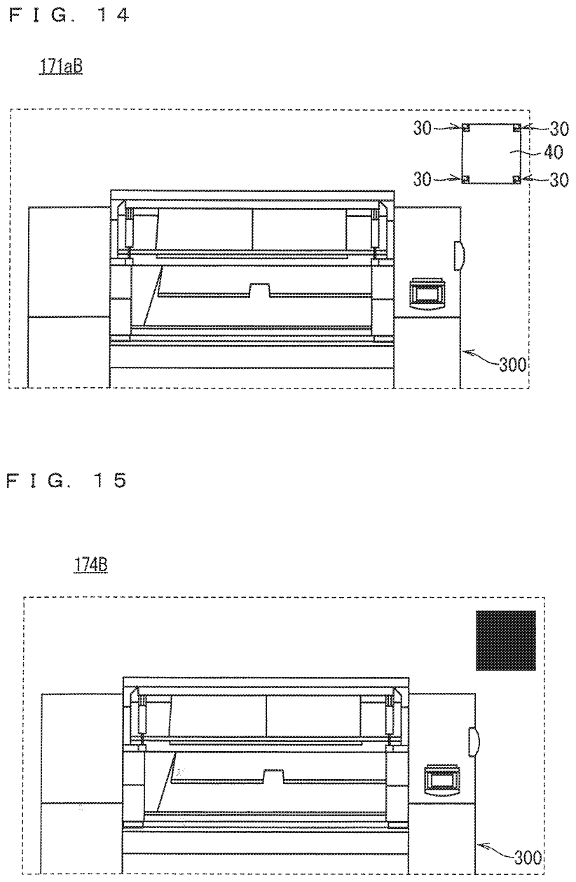

FIG. 14 is a diagram showing, as an example of the original image, an original image 171aB according to the modification. FIG. 15 is a diagram showing, as an example of the processed image, a processed image 174B according to the modification.

In this modification, four identifiers 30 are attached in advance to the confidential information 40 (for example, a device other than the printing device 300 in a factory). When a picture is taken by wearable tool 100, a portion surrounded by the four identifiers 30 in the original image 171aB is identified as the second image portion by the identification unit. Then, a layer filled with black is superimposed on the second image portion, and then the processed image 174B is generated. As described above, the identifier 30 may function as an augmented reality (AR) marker. In other words, the identifier 30 may function as a sign for designating the position and size based on which the first image portion is extracted from the original image as in the above-described embodiment, or in an image recognition type AR system as in the present modification, the identifier 30 may function as a sign for designating a position and a size based on which additional information is displayed.

In the processed image 174B, the second image portion including the confidential information 40 is filled with black with pinpoint accuracy, and the other portion (first image portion) has no change from the original image 171aB. Therefore, when the processed image 174B is displayed on the display screens 132, 232, the worker 10 and the instructor 20 easily grasp a scene within the picture-taking range of the wearable tool 100 with high accuracy. Further, in this modification, when the identification unit fails to identify the second image portion based on the one or more identifiers 30 recognized by the recognition unit, the notification image 175 is output. Further, as another example different from this modification, an aspect may be employed in which the identification unit identifies both the first image portion and the second image portion.

In the above-described embodiment, although a description has been given of the aspect in which the identifiers 30 (a total of four identifiers 30) are provided at the four corners of the printing device 300 with a cover of the printing device 300 opened, and when either of the two pairs of identifiers 30 is recognized by the recognition unit, the branch is made to Yes in step ST3, the present invention is not limited to this aspect.

For example, an aspect may be employed in which when the identifiers 30 (a total of two identifiers 30) are provided at two corners of the four corners located at diagonal positions, and when both of the two identifiers 30 are recognized by the recognition unit, a branch is made to Yes in step ST3. This aspect reduces labor of attaching the identifiers 30 in advance to the device. In contrast, in the aspect in which success in recognizing either of the two pairs of identifiers 30 allows the processed image 174 to be generated as in the above-described embodiment, display of the processed image 174 on the display screens 132, 232 during the maintenance work performed while the video call is in operation is rarely interrupted. Specifically, during maintenance work performed on the printing device 300 by the worker 10 in accordance with an instruction from the instructor 20, even when one or some of the identifiers 30 (for example, the identifier 30 located at the lower right corner shown in FIG. 7) are covered by a hand of the worker 10 and the wearable tool 100 fails to recognize the identifier 30, success in recognizing other identifiers 30 (for example, the identifiers 30 located at the lower left corner and at the upper right corner shown in FIG. 7) in the wearable tool 100 causes the processed image 174 to be continuously generated and displayed on the display screens 132, 232.

Further, it is sufficient that at least one identifier 30 is provided. For example, only the identifier 30 located at the upper right corner shown in FIG. 7 is provided, and the other three identifiers 30 may not be provided. In this case, the one identifier 30 provided at the upper right corner needs to have information for identifying the first image portion. Specifically, for example, the one identifier 30 is defined to have information indicating “a rectangular area in which the one identifier 30 is located at the upper right corner and having a predetermined horizontal length and vertical length corresponds to the first image portion”, and calculation of the first image portion and the like may be made in accordance with the definition. Further, as another example different from this modification, one identifier may have information indicating “a circular area having a predetermined radius with the one identifier 30 as the center corresponds to the second image portion”. Further, in this case, for example, the size of the one identifier 30 is defined to indicate the radius, which allows identifiers of one shape to indicate areas of different sizes.

Conversely, a large number of identifiers are arranged in any shape, which allows an area of any shape to be defined. For example, a method in which a direction is indicated by a mark such as “┌” “┘” or “L” as a two-dimensional code printed on an identifier, or identifiers on which a number is printed are arranged in a single stroke order of the number represents an area of a complicated shape such as a polygon, a concave shape, a convex shape, or a combination thereof.

Further, in the above-described embodiment, although a description has been given of the aspect in which the identifier 30 is a seal having a two-dimensional code, the present invention is not limited to this aspect. An aspect may be employed in which the identifier is formed of an object color and an object shape. For example, an outline shape of the printing device 300 with the cover opened may serve as the identifier. In this case, for example, until the worker 10 wearing the wearable tool 100 opens the cover of the printing device 300, the identifier is not recognized, and the notification image 175 is displayed on the display screens 132, 232. When the worker 10 opens the cover of the printing device 300, the outline shape is recognized as the identifier, and the processed image 174 is displayed on the display screens 132, 232.

Further, in the aspect in which the identifier 30 is a seal having a two-dimensional code, each seal may have a unique size and code. For example, when the identifier 30 is an identifier for identifying the second image portion, an identifier 30 having a relatively large size may be attached to a portion where prevention of information leakage is particularly required. In this case, when the wearable tool 100 takes a picture of an area including the identifier 30 having a small size and the identifier 30 having a large size from a distant place, the identifier 30 having a large size is more easily recognized, and the risk of information leakage becomes lower.

Further, as long as the identifier 30 is recognizable for the recognition unit 115, the identifier 30 may be invisible under visible light.

Further, in the above-described embodiment, although a description has been given of the aspect in which the acquisition unit (camera 170) that acquires the original image and the image processor 114 are housed in the housing 11, and processing from acquisition of the original image to generation of the processed image is performed in the wearable tool 100, the present invention is not limited to this aspect.

For example, the image processing system 1 may be configured so that the wearable tool 100 includes the acquisition unit (camera 170) and the PC 200 includes the image processor 114. In this case, first, the original image that may include the confidential information 40 is transmitted to the PC 200. Then, when the communication unit (a part functioning as the acquisition unit) in the PC 200 acquires the original image, the image processor 114 is activated in response to the acquisition and immediately generates the processed image. Then, the processed image is displayed on the display screens 132, 232. Therefore, even when the image processing is performed in the PC 200, the risk of information leakage in which the original image is presented to the instructor 20 can be prevented. Besides the case where the acquisition unit serves as the picture-taking unit having the original area as the picture-taking range as in the above-described embodiment, the acquisition unit may serve as the communication unit that receives the original image as in the present modification. Further, in the case where main image processing is performed in the PC 200 as in the present modification, the control program Pg1 may be installed in the PC 200 (a computer), and the CPU of the PC 200 may execute the control program Pg1 in the memory.

Further, as another example different from this modification, the image processor 114 including the recognition unit 115, the identification unit 116, and the generation unit 117 may be shared between the wearable tool 100 and the PC 200. Specifically, for example, an aspect may be employed in which the wearable tool 100 includes the recognition unit 115 and the identification unit 116, and the PC 200 includes the generation unit 117. Further, an aspect may be employed in which the wearable tool 100 includes the recognition unit 115, and the PC 200 includes the identification unit 116 and the generation unit 117.

Further, in the above-described embodiment, although a description has been given of the aspect in which the processed image 174 is displayed on the display screens 132, 232 over the video call period, the present invention is not limited to this aspect. For example, in response to acquisition of the processed image 174, the instructor 20 inputs information to be given to the worker 10 from an input unit (for example, a keyboard, a mouse, or the like) of the PC 200. A new image (an image that results from adding, by the instructor 20, the information to the processed image 174) generated by the instructor 20 as described above may be displayed on the display screens 132, 232 over the video call period. The new image is, for example, an image that results from designating, by the instructor 20, a portion to be subjected to maintenance in the processed image 174 with a circle mark. Such a new image is shared between the worker 10 and the instructor 20 with the video call in operation, thereby making smooth communication between the worker 10 and the instructor 20. Note that work instruction contents to be given by the instructor 20 to the worker 10 in relation to the processed image are not limited to the new image described above, and for example, the work instruction contents may be given in the form of a voice instruction to the worker 10 via the receiver 160, or may be given in the form of information that can be received by the wearable tool 100 and recognized by the worker 10.

In the above-described embodiment, although a description has been given of the aspect in which the wearable tool 100 includes the radio communication unit 120 that is provided in the housing 11 and is capable of transmitting the processed image to the device (PC 200) outside the housing 11, the present invention is not limited to this aspect. For example, the wearable tool 100 may include a wired communication unit. Further, the first terminal device used by the worker 10 is not limited to a so-called wearable tool that is attachable to a body, a cloth, or the like of the worker 10, and, for example, the worker 10 may use a portable communication terminal such as a general smartphone held by hand or may use the portable communication terminal fixed with any fixing mechanism such as a tripod. Further, a personal computer (PC) may be used like the second terminal device used by the instructor 20. In this case, it is necessary for the PC to have a camera function for taking a picture. Further, an aspect may be employed in which the wearable tool 100 includes no communication unit. In this aspect, in a certain time after the processed image is stored in the storage unit 112, the processed image retrieved from the storage unit 112 is input to another apparatus (for example, the PC 200). In this aspect, although real-time communicate is not allowed between the wearable tool 100 and the PC 200, an effect of reducing information leakage while lightening the burden on the picture-taker that is identical to the effect in the above-described embodiment can be obtained.

In the above-described embodiment, although a description has been given of the aspect in which the mounting unit 12 of the wearable tool 100 is provided outside the housing 11 and is mountable on the head of the worker 10, the present invention is not limited to this aspect. Various aspects can be employed as long as the mounting unit is mountable on the body of the worker 10 or the cloth of the worker 10.

Further, in the above-described embodiment, although a description has been given of the aspect in which the processed image is displayed on the display screens 132, 232 as an aspect in which the processed image is visually output by the output unit, the present invention is not limited to this aspect. An aspect may be employed in which, in addition to such a screen display, the processed image may be projected on a screen or the like.

Further, in the above-described embodiment, although a description has been given of the aspect in which the image processing system 1 is used between the worker 10 and the instructor 20 for the maintenance work on the printing device 300, the present invention is not limited to this aspect. The image processing system 1 may be used in various ways between a picture-taker who takes a picture of a certain area and a viewer who views at least a part of the taken picture (that is, the processed image).

Although a description has been given of the image processing system, the image processing program, and the image processing method according to the embodiment and the modifications, the image processing system, the image processing program, and the image processing method are examples of a preferred embodiment of the present invention and are not intended to limit the scope of the present invention. According to the present invention, it is allowed to freely combine each embodiment, modify any component of each embodiment, or increase or decrease any component of each embodiment within the scope of the invention.

### EXPLANATION OF REFERENCE SIGNS

1: image processing system
10: worker
20: instructor
30: identifier
100: wearable tool
113: communication processor
114: image processor
115: recognition unit
116: identification unit
117: generation unit
132, 232: display screen
171 to 173: original area
171a to 173a, 171aB: original image
174, 174A, 174B: processed image
200: PC
300: printing device

1. An image processing system comprising:
an acquisition unit acquiring an original image capturing an original area;
a recognition unit recognizing one or more identifiers in said original image;
an identification unit identifying, based on said one or more identifiers recognized by said recognition unit, at least one of a first image portion capturing a first area in said original area and a second image portion capturing a second area that results from removing said first area from said original area; and
a generation unit generating a processed image including said first image portion in accordance with a result of identification from said identification unit.

2. The image processing system according to claim 1, wherein said generation unit edits said second image portion to make said second area visually unrecognizable and generates said processed image that includes said first image portion and said second image portion thus edited.

3. The image processing system according to claim 1, wherein said generation unit generates said processed image that does not include said second image portion but includes said first image portion.

4. The image processing system according to claim 1, further comprising an output unit visually outputting said processed image.

5. The image processing system according to claim 4, wherein said output unit outputs said processed image immediately in response to acquisition of said original image in said acquisition unit.

6. The image processing system according to claim 4, wherein when said identification unit fails to identify either said first image portion or said second image portion based on said one or more identifiers recognized by said recognition unit, a notification image for notifying a user of failure of identification is output to said output unit.

7. The image processing system according to claim 1, further comprising a housing that is portable and houses said acquisition unit, said recognition unit, said identification unit, and said generation unit, wherein
said acquisition unit is a picture-taking unit having said original area as a picture-taking range.

8. The image processing system according to claim 7, further comprising a mounting unit that is provided outside said housing and mountable on a body of a picture-taker or a cloth of the picture-taker.

9. The image processing system according to claim 7, further comprising a communication unit that is provided in said housing and capable of transmitting said processed image to a device located outside said housing.

10. An image processing system comprising:
a first terminal device including a picture-taking unit used by a picture-taker to take a picture of an original area to acquire an original image;
a recognition unit recognizing an identifier for dividing said original image into a first image portion and a second image portion;
an identification unit identifying, based on one or more of said identifiers recognized by said recognition unit, at least one of said first image portion capturing a first area to be provided to a viewer and said second image portion capturing a second area not to be provided to the viewer in said original image;
a generation unit generating, in accordance with a result of identification from said identification unit, a processed image including said first image portion having said first area visually recognizable and said second image portion edited to make said second area visually unrecognizable; and
a second terminal device including a display unit displaying said processed image to said viewer.

11. The image processing system according to claim 10, wherein said first terminal device further includes a reception unit used by said picture-taker to receive information from said viewer.

12. The image processing system according to claim 10, wherein said second terminal device further includes an input unit used by said viewer to input information to be given to said picture-taker in response to acquisition of said processed image.

13. A non-transitory computer readable recording medium storing an image processing program installed in a computer and executed in a memory by a CPU to cause said computer to function as the image processing system according to claim 1.

14. An image processing method comprising:
disposing an identifier for defining a first image portion and a second image portion;
acquiring an original image capturing an original area;
recognizing one or more of said identifiers in said original image;
identifying, based on said one or more identifiers thus recognized, at least one of said first image portion capturing a first area in said original area and said second image portion capturing a second area that results from removing said first area from said original area; and
generating a processed image including said first image portion in accordance with a result of identification.

15. An image processing system comprising:
one or more processors;
a camera connected to the one or more processors;
a display connected to the one or more processors; and
a computer-readable memory storing thereon instructions that, when executed by the one or more processors, cause the image system to:
acquire an original image capturing an original area from the camera;
recognize one or more of identifiers in said original image, said one or more identifiers being for defining a first image portion and a second image portion;
identify, based on said one or more identifiers thus recognized, at least one of said first image portion capturing a first area in said original area and said second image portion capturing a second area that results from removing said first area from said original area; and
generate a processed image including said first image portion in accordance with a result of identification and output the processed image to the display so that the processed image is displayed on the display.
